(19) United States
(12) Patent Application Publication
(10) Pub. No.: US 2011/0227324 A1
(43) Pub. Date: Sep. 22, 2011

(54) PARATRANSIT LIFT WITH SAFETY BELTS

(76) Inventors: DALE BINKLEY, Loveland, CO (US); Ralph Mason, Louisville, CO (US)

(21) Appl. No.: 13/049,354

(22) Filed: Mar. 16, 2011

Related U.S. Application Data
(60) Provisional application No. 61/314,722, filed on Mar. 17, 2010.
(60) Provisional application No. 61/347,250, filed on May 21, 2010.

(51) Int. Cl. B60R 22/00; B60P 1/44; A61G 3/06

(52) U.S. Cl. 280/801.1

(57) ABSTRACT

A paratransit lift is provided with safety belts with separable components. The components are configured for attachment of the lift without any alteration of the lift structure.

### RELATED APPLICATIONS

This application claims the benefit of U.S. Provisional Patent Applications No. 61314722 filed on Mar. 17, 2010 and No. 61347250 filed on May 21, 2010.

### BACKGROUND OF THE INVENTION

The present invention generally relates to paratransit lift systems and more particularly to safety devices from such lifts.

Paratransit lifts typically provide an elevating platform onto which a person with limited personal mobility may be positioned for transfer between ground level and a floor of a vehicle. For example, the limited-mobility person may be in a wheel chair or may use a walker. The person may enter the platform with or without assistance. In either case, there is a risk that the person and/or the person's wheel chair may not remain securely on the platform as the platform moves to an elevated or lowered position.

As can be seen, there is a need for a safety system that may be employed to assure that an occupant of a paratransit lift platform may be prevented from accidentally falling from the platform. Additionally, there is a need for such a system that may be conveniently used by an operator of the lift and does not require modifications of the lift which might require regulatory re-certification of the lift.

### SUMMARY OF THE INVENTION

In one aspect of the present invention, a paratransit lift may comprise at least one safety belt with separable components wherein the components are configured for attachment of the lift without any alteration of the lift structure.

In another aspect of the present invention, a safety belt for a paratransit lift may comprise: two lengths of webbing; a separable latch positioned between the two lengths of webbing at first ends of the webbing; and bolt-attachment grommets at second ends of the webbing opposite the first ends.

In still another aspect of the present invention, a safety belt for a paratransit lift may comprise: two lengths of webbing; a separable latch positioned between the two lengths of webbing at first ends of the webbing; and attachment loops at second ends of the webbing opposite the first ends.

These and other features, aspects and advantages of the present invention will become better understood with reference to the following drawings, description and claims.

### BRIEF DESCRIPTION OF THE DRAWINGS

FIG. 1 is a perspective view of a paratransit lift in accordance with an embodiment of the invention;

FIG. 2 is a perspective view of the paratransit lift of FIG. 1 in a raised position;

FIG. 3 is a plan view of a rear safety belt in accordance with an embodiment of the invention;

FIG. 4 is a perspective view of a front safety belt in accordance with an embodiment of the invention; and

FIG. 5 is a detailed view of a loop portion of the safety belt of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide safety belts at a front and a back side of a paratransit lift that may prevent an occupant of the lift from accidentally falling from the lift.

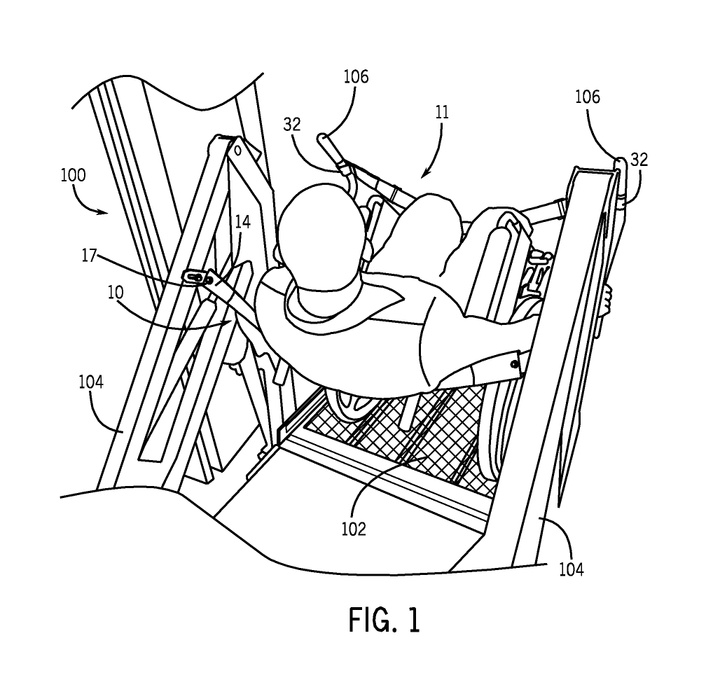

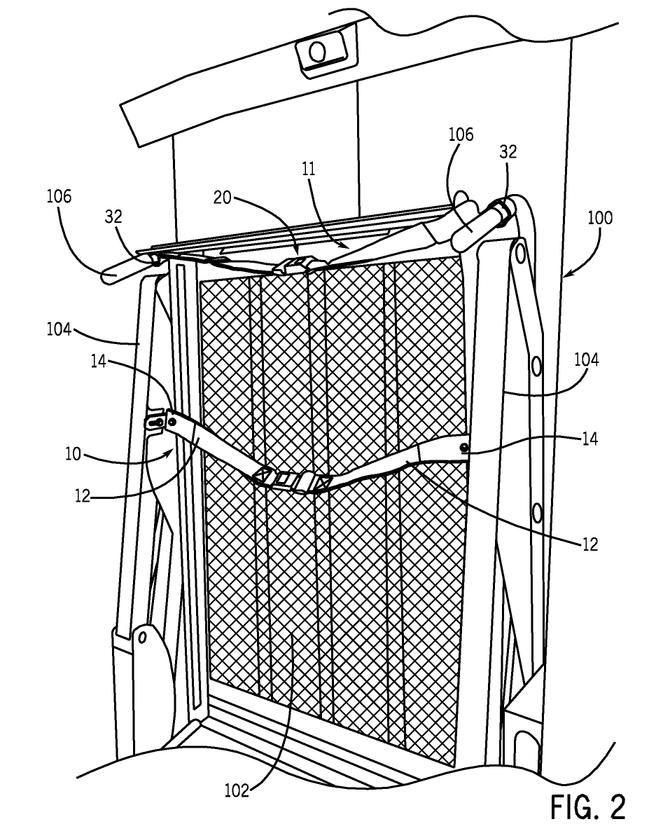

Referring now to FIGS. 1 and 2 it may be seen that a paratransit lift 100 may comprise a platform 102, lifting arms 104 and handles 106. In operation, the lift 100 may be attached to a vehicle so that a person may enter the platform 102 and be lowered to the ground or lifted to floor height of the vehicle.

The lift 100 may be provided with a rear safety belt 10 and a front safety belt 11. The safety belts 10 and 11 may be provided with latches 20 (e.g., seat-belt latches) so that the safety belts may be opened or closed as desired. As an occupant enters the platform 102 from the vehicle, the front safety belt 11 may be kept closed and the rear belt 10 may be opened. After the occupant is on the platform 102, the rear safety belt 10 may be closed. As the lift platform 102 moves to ground level, the occupant may be prevented from falling from the platform 102 even if the occupant inadvertently tilts a wheelchair backward or moves the wheel chair forward. This process may be reversed when the occupant is moved from ground level to floor level of the vehicle.

In an exemplary embodiment of the invention, the safety belts 10 and 11 may be configured so that they may be attached to a conventional paratransit lift without a need for any modifications of the lift.

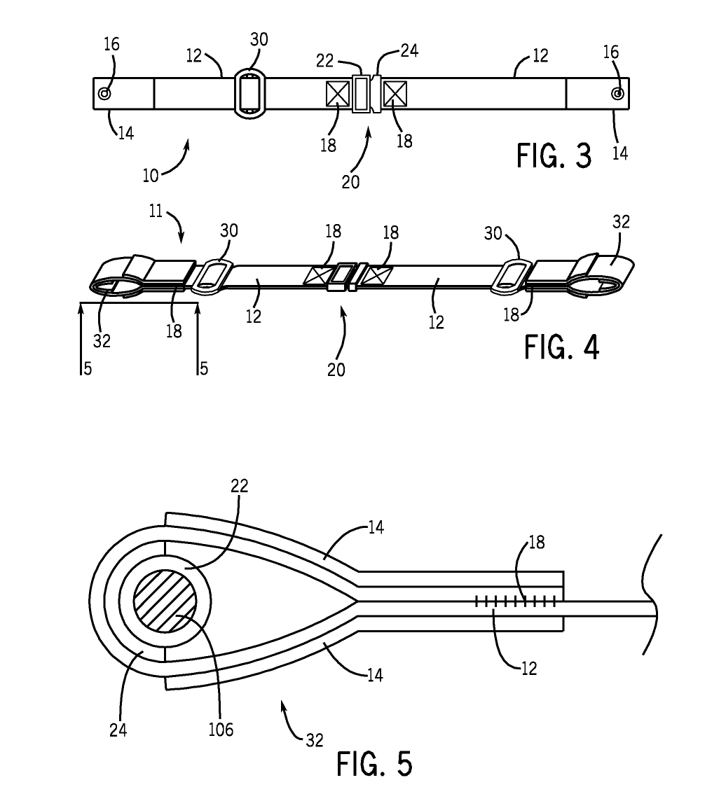

Referring now to FIG. 3, the rear safety belt 10 may comprise two lengths of webbing 12 (e.g., nylon webbing). The latch 20 may be attached to the webbing 12 with box stitching 18. Abrasion resistant reinforcement 14 (e.g. Kevlar® fabric) may be attached to ends of the webbing 12 and a grommet 16 may be placed through the reinforcement 14 and the webbing 12. The grommet 16 may be large enough to accommodate a bolt 17 so that the safety belt 10 may be attached to the lifting arms 104 with bolts 17. It may be noted that conventional paratransit lifts typically have assembly bolts located on each of the lifting arms 104. One or more of these assembly bolt locations may be employed for the bolt 17. A preexisting bolt of the lift 100 may be removed and the bolt 17 may be passed through the grommet 16 and then placed into a pre-existing bolt location in the arm 104, thus precluding a need to perform any drilling or other modifications of the paratransit lift.

Referring now to FIGS. 4 and 5, the front safety belt 11 may comprise two lengths of the webbing 12. The latch 20 may be attached to the webbing 12 with box stitching 18. Attachment loops 32 may be formed at ends of the webbing 12. The loops 32 may be employed to attach the front safety belt 11 to the handles 106 of the lift 100.

Referring now to FIG. 5, it may be seen that a hook and loop attachment system (e.g., Velcro®) may be employed for holding the front safety belt 11 on the lift 100. Each of the handles 106 of the lift 100 may be wrapped with a piece of hook and loop material (e.g., a hook member 22). The hook member 22 may be adhesively secured to the handle 106. A piece of the hook and loop material (e.g., a loop member 24) may be adhesively secured within the loop 32. When the loop 32 is placed over the handle 106 the hook member 22 and the loop member 24 may engage with one another to hold the safety belt 11 in position on the handle 106. As is the case with the rear safety belt 10, there is no need to perform any modification of the lift 100 in order to attach the front safety belt 11 to the lift 100.

Some of the abrasion reinforcement 14 may be applied to the safety belt 11 so that chafing damage of the belt 11 may be prevented when the lift platform 102 is in its retracted position as shown in FIG. 2. Additionally the safety belt 11 may be provided with length-adjustment buckles 3

The latches 20 may be provided with an internal battery-operated audible alarm system that may notify a lift operator that the latches 20 may not be connected as required.

It should be understood, of course, that the foregoing relates to exemplary embodiments of the invention and that modifications may be made without departing from the spirit and scope of the invention as set forth in the following claims.

What is claimed is:

1. A paratransit lift comprising at least one safety belt with separable components wherein the components are configured for attachment of the lift without any alteration of the lift structure.

2. The paratransit lift of claim 1 wherein the components are attached to handles of the lift with hook and loop fastening material.

3. The paratransit lift of claim 1 wherein the components are attached to lifting arms of the lift with bolts placed at preexisting bolt locations.

4. The paratransit lift of claim 1 comprising:
a front safety belt with its separable components attached to handles of the lift with hook and loop fastening material; and
a rear safety belt with its separable components attached to lifting arms of the lift with bolts placed at preexisting bolt locations.

5. The paratransit lift of claim 4 wherein the front and rear safety belts comprise latches with internal audible alarms that sound when the latches are not connected.

6. A safety belt for a paratransit lift comprising;
two lengths of webbing;
a separable latch positioned between the two lengths of webbing at first ends of the webbing; and
bolt-attachment grommets at second ends of the webbing opposite the first ends.

7. The safety belt of claim 6 wherein the grommets have a diameter suitable to accommodate bolts that have a diameter the same as preexisting bolts of lifting arms of the paratransit lift.

8. A safety belt for a paratransit lift comprising:
two lengths of webbing;
a separable latch positioned between the two lengths of webbing at first ends of the webbing;
attachment loops at second ends of the webbing opposite the first end.

9. The safety belt of claim 8 further comprising portions of hook and loop material attached to interiors of the attachment loops.

10. The safety belt of claim 8 further comprising abrasion resistant reinforcement attached to exteriors of the attachment loops.
